(19) United States
(12) Patent Application Publication
(10) Pub. No.: US 2005/0044127 A1
(43) Pub. Date: Feb. 24, 2005

(54) Dynamic load distribution within a session initiation protocol network

(76) Inventors: Vivek Jaiswal, Bangalore (IN); Amit Kaul, Bangalore (IN)

Correspondence Address: BUCKLEY, MASCHOFF, TALWALKAR LLC, 5 ELM STREET, NEW CANAAN, CT, 06840, US

(21) Appl. No.: 10/642,702

(22) Filed: Aug. 18, 2003

(51) Int. Cl. G06F 15/16

(52) U.S. Cl. 709/200

(57) ABSTRACT

A system, an apparatus, and a method for distributing load dynamically in a session initiation protocol network.

### BACKGROUND

Efforts are being made to bring carrier-grade quality into networks that carry IP Telephony and Multimedia. Voice communication, or telephony, has been attempted to be performed in near real time over networks such as the Internet. Such networks establish video, audio or data sessions by communicating signaling information in packets. Such networks may experience a discernible delay during session establishment and tearing down, particularly when transmission occurs through busy intermediate nodes. Such delays are unacceptable to customers who transition from PSTN carrier grade quality to IP telephony. Load balancing, which aims to distribute tasks among intermediate nodes to equalize the level of operation of those nodes may be utilized with network based telephony to achieve PSTN carrier grade quality.

### BRIEF DESCRIPTION OF THE DRAWINGS

The accompanying drawings, wherein like reference numerals are employed to designate like components, are included to provide a further understanding of the present dynamic load distribution within an SIP network, are incorporated in and constitute a part of this specification, and illustrate embodiments of dynamic load distribution within an SIP network that together with the description serve to explain the principles of the present dynamic load distribution within an SIP network.

In the drawings:

FIG. 1 is a block diagram of a system suitable for practicing an embodiment of dynamic load distribution within an SIP network;

FIG. 2 is a block diagram of a device suitable for practicing an embodiment of dynamic load distribution within an SIP network;

FIG. 3 is another block diagram of a device suitable for practicing an embodiment of dynamic load distribution within an SIP network;

FIG. 4 is a flow diagram employed at an SIP network entity in an embodiment of dynamic load distribution within an SIP network; and

FIG. 5 illustrates node communication in an embodiment of dynamic load distribution within an SIP network.

### DETAILED DESCRIPTION

Reference will now be made to preferred embodiments of the present dynamic load distribution within an SIP network, examples of which are illustrated in the accompanying drawings. Other details, features, and advantages of the dynamic load distribution within an SIP network techniques will become further apparent in the following detailed description of embodiments thereof.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification are not necessarily all referring to the same embodiment References to “or” are furthermore intended as inclusive so “or” may indicate one or another of the ored terms or more than one ored term.

The Session Initiation Protocol (SIP) is an Internet Engineering Task Force (IETF) standard protocol for initiating an interactive user session that involves multimedia elements such as video, voice, chat, and gaming. The SIP standard may be found at “www.ietf.org,” under Request for Comment (RFC) 3261, published June 2002. An SIP Extension standard, having to do with Specific Event Notification may also be found at “www.ietf.org,” under RFC 3265, published June 2002. Together, those standards will be referred to as the “SIP Standards” herein.

SIP has its roots in the “multicast backbone,” which was created to be a multicast network overlaid on top of the Internet. The multicast backbone was used for distribution of multimedia content. One of the essential components of the multicast backbone was a method for inviting users to listen in on an ongoing or future multimedia session, essentially a session initiation protocol.

SIP may be an application-layer control protocol when used in the Open Systems Interconnection (OSI) communications model that can establish, modify, and terminate multimedia sessions or calls. The basic architecture of SIP is client/server in nature and utilizes a request-response protocol, dealing with requests and responses between clients and servers. Nodes or entities in an SIP network are identified by SIP URIs. Requests can be sent through any transport protocol, such as UDP (User Datagram Protocol), SCTP (Stream Control Transmission Protocol), or TCP (Transmission Control Protocol).

As the SIP protocol is involved primarily with call initiation and termination, SIP generally determines the end system to be used for the session, the communication media and media parameters, and the called party's desire to engage in the communication. Once those are assured, SIP establishes call parameters at the caller and receiver ends of the communication, and handles call initiation and termination.

An SIP “session” is described by content carried in SIP messages. SIP can operate in connection with both persons and “robots,” such as a media storage service used to place, keep, and retrieve data on a long-term basis. SIP can furthermore be utilized with both unicast and multicast sessions. SIP can initiate sessions and invite members to sessions that have been advertised and established by other means. Sessions can be advertised using multicast protocols such as SAP, electronic mail, news groups, web pages, or directories.

SIP can be used to change a session as well. The creator may, for example, re-initiate a session, re-sending the same message, but with a new session description.

The Internet is a network of nodes such as computers, dumb terminals, SIP enabled telephones, or other, typically processor-based, devices interconnected by one or more forms of communication media. The communication media coupling those devices include twisted pair, co-axial cable, optical fibers and wireless communication methods such as use of radio frequencies.

Network nodes may be equipped with the appropriate hardware, software, or firmware necessary to communicate information in accordance with one or more protocols. A protocol may comprise a set of instructions by which the information is communicated over the communications medium. Protocols are, furthermore, often layered over one another to form something called a “protocol stack.” In one embodiment of the invention, the network nodes operate in accordance with a packet switching protocol referred to as the User Datagram Protocol (UDP) as defined by the Internet Engineering Task Force (IETF) standard 6, Request For Comment (RFC) 768, adopted in August, 1980 (“UDP Specification”), and the Internet Protocol (IP) as defined by the IETF standard 5, RFC 791 (“IP Specification”), adopted in September, 1981, both available from “www.ietf.org.” In another embodiment, Transmission Control Protocol (TCP) as defined by the Internet Engineering Task Force (IETF) standard 7, Request For Comment (RFC) 793, adopted in September, 1981 (“TCP Specification”) may be used with IP. Stream Control Transmission Protocol (SCTP) may also be utilized in connection with an embodiment. SCTP is defined by IETF RFC 2960, published October 2000.

“Transmitting entities” and “receiving entities” are network nodes that may include a processor or a computer having a microphone and a speaker, that is coupled to a network such as, for example, the Internet, and that communicates with other processors on the network via, for example, a voice over IP application or a conferencing application (e.g., Microsoft® Netmeeting®) that communicates between applications operating on the node or entity and the UDP/IP protocol stack. UDP is a network communications protocol that offers lesser services than TCP. For example, UDP may provide port numbers to distinguish different user requests and a checksum to verify that data arrived intact. UDP may not provide sequencing of the packets or retransmission of unreceived packets. After the packets are created, the IP layer transmits the packets across a network such as the Internet.

Nodes may operate as source nodes, destination nodes, intermediate nodes or a combination of those source nodes, destination nodes, or intermediate nodes. Information is passed from source nodes to destination nodes, often through one or more intermediate nodes. Information may comprise any data capable of being represented as a signal, such as an electrical signal, optical signal, acoustical signal and so forth. Examples of information in this context may include signaling messages.

Packet-based networks such as, for example, those using X.25, frame-relay, cell-relay, or asynchronous transfer mode (ATM) may not be synchronous. Thus, a transmission sent over a non-synchronous network may be separated into a plurality of packets. Those packets may then be sent across the network, possibly by a variety of routes and, sometimes, with certain packets taking a discernable interval of time to arrive at a receiving entity. The receiving entity arranges the packets back into the transmitted information periodically, for example, once all packets are received or each time the next packet of streaming type information is received and then may deliver the transmitted information to a user in the order in which that information is to be reconstructed.

Typical nodes that exist in an SIP network include user agents, proxies, back-to-back user agents (B2BUA), a registrar, redirect server, and a location server. The user agents may be clients that often act as transmitting entities and receiving entities. A proxy typically acts as an intermediate node that passes information, such as signaling information for creation of a session, from a transmitting entity to a receiving entity. Multiple proxies may be involved in passing such information. A B2BUA may operate as a proxy and may also communicate with a registrar or location service regarding the locations of nodes in the SIP network. It should be noted that multiple logical entities may be co-located in a single physical device. The registrar typically updates the location service with the addresses and contact information of all registered user agents and B2BUAs. The location service may furthermore store the contact information.

A redirect server may redirect the call using 3xx class responses as specified in the SIP standard. If a call is redirected, the server provides one or more alternate contacts, which are nodes that may be used in transmitting SIP information, in the 3xx class response. A Q-value may be associated with each contact to indicate a priority that relates to which contact is to be used where multiple contacts are available. An entity receiving a 3xx class response may redirect the call after choosing the contact to be utilized based on the associated Q-value.

Load distribution in SIP may, for example, use static methods like those used in a Domain Name System (DNS). A DNS is utilized by the Internet to locate Internet Protocol (IP) addresses associated with domain names. Lists of domain names and associated IP addresses are generally distributed throughout the Internet in a hierarchy of authority. DNS servers may thus be located throughout a network such as the Internet and nodes proximate to a DNS server may access that DNS server to determine locations of desired nodes.

Dynamic load distribution within an SIP network systems, apparatuses, and methods are contemplated. Those dynamic load distribution within an SIP network, apparatuses, and methods distribute network based telephony calls among nodes based on the demand placed on each of those nodes and, where applicable, that demand load may be weighted in relation to the capacity of each node.

Those nodes may be, for example, back-to-back user agents (B2BUA) or proxies, which will be referred to herein as server nodes and typically act as intermediate nodes in an SIP network. Moreover, a proxy may act as an intermediate node that routes SIP signaling information from source nodes to destination nodes.

Those nodes may also be user agents that are used as source nodes or destination nodes and are referred to as transmitting entities and receiving entities, respectively. The following examples will describe dynamic load distribution within an SIP network as applied to server nodes because server nodes often provide numerous processing intensive functions such as address-resolution, call forwarding, tracking of billing information, and event notification, and so may be more loaded than user agents.

Capacity of a node may be considered in connection with the demand incident on those nodes where, for example, various server nodes have varying capacities such that the portion of capacity utilized, accurately describes the comparative load or demand placed on each server node. Capacity or Load Factor of a node may be based on a variety of factors including call capacity, processing capability, network bandwidth, network availability, or a combination of those or other factors.

In an embodiment, a dynamic load distribution within an SIP network system is contemplated. That system includes a transmitting entity, a receiving entity, a first server, a second server, and a load broker. The transmitting entity is to transmit information. The receiving entity is to receive the transmitted information. The first server and second server are to relay the information from the transmitting entity to the receiving entity. The load broker is to track the load on each of the first server and the second server and to help in effective load distribution within an SIP network.

In another embodiment, an article of manufacture includes a computer readable medium having instructions stored thereon. When the instructions are executed by a processor, the instructions cause the processor to determine a load on a first node and a load on a second node, factor the load for at least one of the first node and the second node into a session initiation protocol Q-value, and direct a transmitting node to relay information through one of the first node and the second node based on the load factor. The transmitting node may be directed to relay information by receiving appropriate load information contained in the session initiation protocol Q-value.

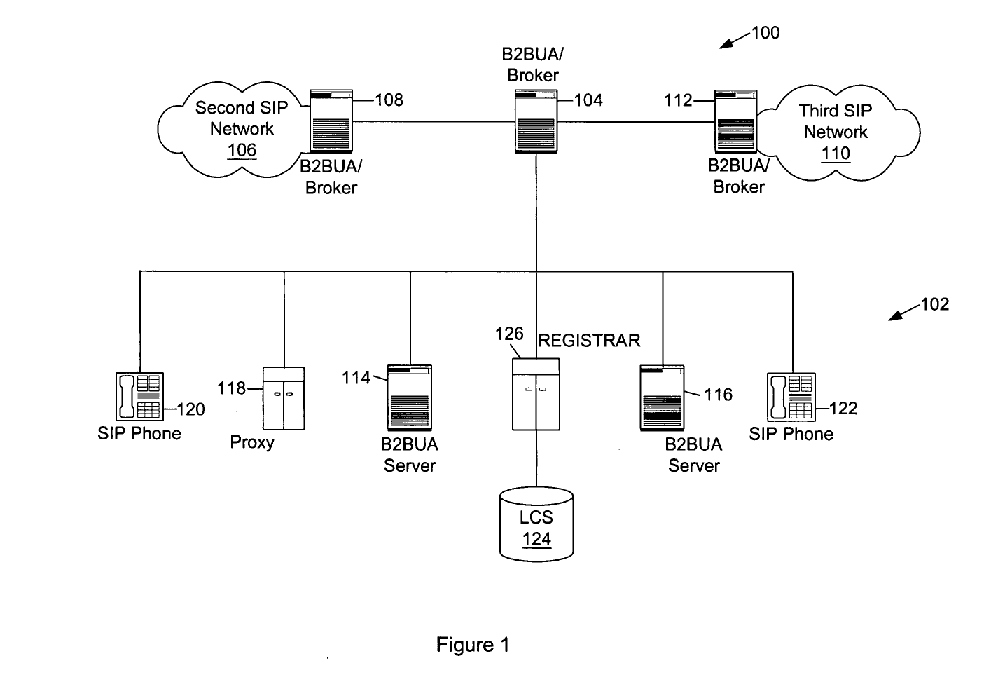

FIG. 1 illustrates an embodiment of a dynamic load distribution within an SIP network system 100. The dynamic load distribution within an SIP network system 100 includes three SIP networks. A subject SIP network 102 communicates signaling information with other SIP networks through a B2BUA broker 104. A second SIP network 106 communicates with the subject SIP network 102 through a second B2BUA broker 108. A third SIP network 110 communicates with the subject SIP network through a third B2BUA broker 112. The second and third SIP networks 108 and 112 are not illustrated in detail with all nodes making up those networks 108 and 112 because they are shown to illustrate communication between SIP networks.

The subject SIP network 102 includes a first B2BUA server 114 and a second B2BUA server 116 coupled to the network 102. A proxy 118, a first SIP phone 120, and a second SIP phone 122 are also coupled to the network 102. A location service (LCS) 124, which may not be a part of the SIP network 102, is utilized to maintain a cross-reference of locations of entities in the network including, if applicable, locations of entities in coupled networks. Any desired location information may be included such as, for example, universal resource identifiers for entities associated with addresses for those entities and Q-values for those entities.

A registrar 126 is also included in the network 102. The registrar 126 may be an SIP server that accepts registration requests and provides information regarding locations of SIP registered entities to the location service 124. Entities including the B2BUA broker 104, B2BUA servers 114 and 116, and the SIP phones 120 and 122 may register with the registrar 126. The registrar 126 may furthermore be incorporated into the B2BUA broker 104.

An SIP load balancing device, which may be referred to as a load broker, is contemplated. The SIP load balancing device includes a network adaptor coupled to a network for communicating with other entities on a network, an SIP load module receiving SIP load information from SIP entities on the network that are to be load balanced, and a calculation module that provides the least loaded of the entities to a querying entity through the network adaptor. The SIP load balancing device may include a table of SIP entities ranked from least loaded to most loaded and may inform a requesting node of the least loaded of a group of nodes, wherein the group of nodes may be next hop candidates.

In an embodiment of a location service, SIP load factor information is included in the calculation of a Q-value and that Q-value is stored in connection with each SIP load aware entity in a location service. Q-value may be an integer value indicating a ranking of preference of use of an entity and that integer may be determined by consideration of a variety of functions including, for example, previously established contact priority and current loading of the entity. The location service may then be queried by entities seeking a next hop entity and the location of the entity having the highest Q-value is returned to the querying entity for use in selecting the next hop entity to be used. The Q-value may, for example, be transmitted from node to node in an SIP contact header as described in the SIP specification.

The Q-value may be a function of the priority in which SIP entities may be used to pass SIP information. The Q-value may, for example, be based on the number of calls being processed by an entity or the amount of information being processed for each call. That Q-value may thus be determined for each SIP entity and may be shared between SIP entities. That sharing may occur directly between SIP entities or through one or more central repositories such as location services or load brokers associated with each administrative domain sub-network. An intermediate node entity that receives SIP information will thus know the priority of neighboring entities and forward that information to a next hop entity having the highest Q-value, which is to say the highest priority.

An administrative domain sub-network may be a collection of SIP nodes with a single location service and a single registrar. A device may serve multiple functions, serving, for example, as a location service, registrar, B2BUA, and load broker.

A domain load factor may also or alternately be determined. Such a domain load factor may be an aggregate of the load factors of the SIP entities within that domain and may be used to indicate the load on an entire domain. That domain load factor may then be shared with neighboring domains so that calls may be routed around busy domains and through lightly loaded domains.

In an embodiment, the Q-value may be determined based on a degree to which each entity is loaded, for example, utilizing a load factor. In addition, or alternately, the Q-value may be based on a contact priority that is predefined and relates to entities that the transmitting entity has set as preferred intermediate entities. Embodiments described herein assume that the Q-value is a function of both contact priority and load factor.

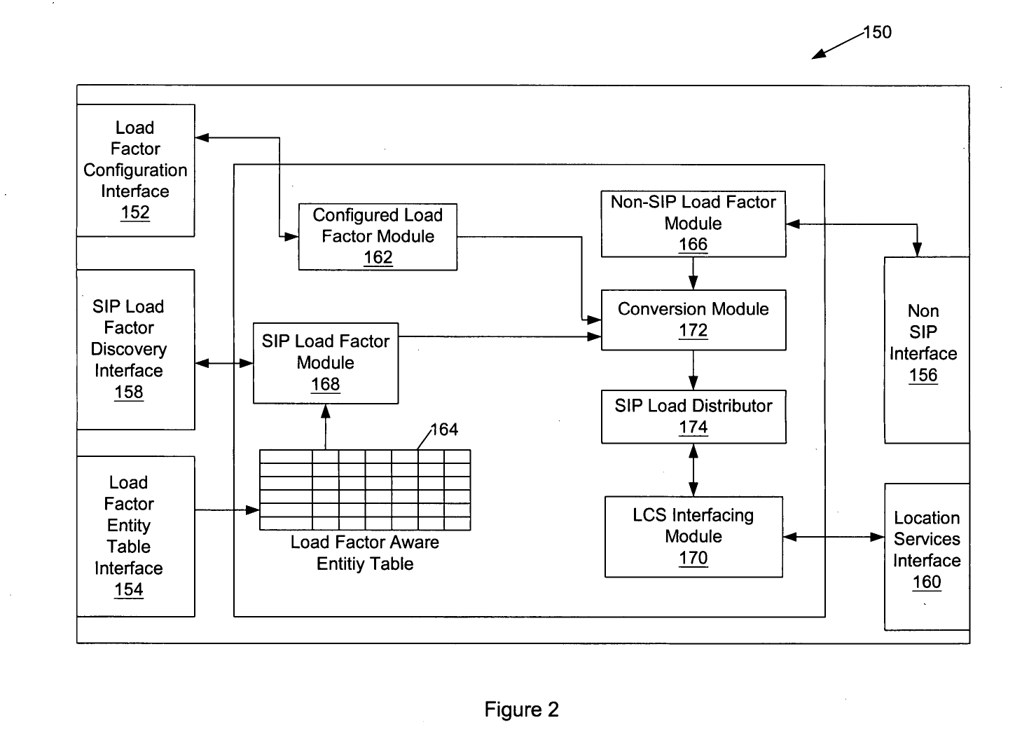

FIG. 2 illustrates an embodiment of a B2BUA SIP aware load broker 150. In its load broker function, the B2BUA SIP aware load broker 150 is an agent used to control and manage load distribution in the SIP network. That load broker 150 is furthermore combined with B2BUA functionality in a single node, as was the B2BUA broker 104 illustrated in FIG. 1. The load broker 150 may alternately be combined in a node that also performs other SIP or non-SIP functions, or may be embodied in a stand-alone node. The load broker 150 illustrated considers an SIP load factor and a non-SIP load factor. Alternately, the load broker 150 could consider only an SIP load factor.

The SIP aware load broker 150 includes five external interfaces and processes information communicated through those interfaces. The five external interfaces include a load factor configuration interface 152, a load factor entity table interface 154, a non-SIP load broker interface 156, an SIP load factor discovery interface 158, and a location service interface 160.

The load factor configuration interface 152 may be used to receive load factor and associated information from an external node or user. That load factor information may include algorithms on which load factor calculations are based. For example, if load factor is based on processor usage divided by processor capacity for each SIP server in the network, then the algorithm for that load calculation may be entered into the SIP aware load broker 150 through the load factor configuration interface 152. Processor capacity may also be entered through the load factor configuration interface 152 and updated each time a processor is added or changed. Alternately, load factor and associated information may be discovered from each SIP server through the SIP load factor discovery interface 158. Moreover, current algorithms or data utilized by the SIP aware load broker 150 may be read from the SIP aware load broker 150 at the load factor configuration interface 152. Information received by the SIP aware load broker 150 may be transferred to a configured load factor module 162.

The load factor entity table interface 154 is an interface through which addresses of SIP entities or nodes for which load factors are to be calculated may be updated. Through this interface, an administrator or routing discovery protocol may add, delete, or update the addresses of those SIP entities coupled to the network. Information entering the SIP aware load broker 150 may be entered into a load factor aware entity table 164 and information read from the SIP aware load broker 150 may be read from the load factor aware entity table 164.

The non-SIP load broker interface 156 permits the SIP aware load broker 150 to communicate with non-SIP entities. Non-SIP load factor information or other desired information may thus be communicated to the SIP aware load broker 150 through the non-SIP load broker interface 156 and information may also be communicated to the non-SIP entities from the SIP aware load broker 150 through the non-SIP load broker interface 156. Information communicated to the SIP aware load broker 150 through the non-SIP load broker interface 156 may be processed in a non-SIP load factor module 166 and translated to SIP load factor using the services of conversion module 172.

The SIP load factor discovery interface 158 may exchange load factor information with other participating network nodes. Methods used to exchange load factor information on the SIP load factor discovery interface 158 may be based, in whole or in part, on the SIP Event Package Subscribe and Notify functions.

The location service interface 160 may interface the SIP aware load broker 150 to a location service such as the location service 124 illustrated in FIG. 1. The location service interface 160 may be used to read, write, and update contact information for network nodes. This interface may be based on one or more SIP or non-SIP protocols. In a SIP network, the location service add, delete, and modify functions may be performed by a Registrar Node and read by any non-Registrar node. A load broker node may perform the Registrar Node function and add, delete, and modify contact information for network nodes. The load broker may perform those add, delete, and modify functions to update the Q-values in the contact information present in the location service database. That action may furthermore be performed by the load broker 150, through the location service interface 160, whenever a new or refreshed load factor value is received through the SIP load factor discovery interface 158 or the load factor configuration interface 152 and which, as a result and through conversion module 172, may generate one or more new Q-values that may be used to read, write, or update contact information for network nodes.

The SIP aware load broker 150 manipulates the information received through the interfaces 152-160 to balance the SIP load amongst the SIP entities. The SIP load factor module 168 may use a variant of the SIP Event Package Subscribe and Notify functions, which are described in the SIP standards, to exchange SIP load factor information within a local administrative domain in a network or with one or more remote administrative domains within the network. The SIP aware load broker 150 may obtain the address of load factor aware nodes, or nodes that have a load factor, in local and remote administrative domains through the SIP load factor entity table interface 154.

Load factors for each entity or node that is load factor aware are stored in a load factor entity table 164. The entities that are load factor enabled may be added to the table, deleted from the table, or modified through the load factor entity interface 154. When a new entry is added in the load factor entity table 164, the SIP aware load broker 150 may communicate with an entity associated with that entry to retrieve information including loading level information from that entity through the load factor module 168. The load factor module 168 may communicate with the new entity and other load factor aware entities to update load factor information in the load factor table 164 through the SIP load factor discovery interface 158. Communication with load factor aware entities may be performed by the SIP aware load broker 150 subscribing to a load factor event package on the new entity using Subscribe, as described in the SIP standards. The load factor event package may be customized by users of various SIP networks to exchange load factor information.

The load factor event package may ensure regular updates of information related to the load factor from each load factor aware entity to the SIP aware load broker 150. That sending of information may be performed using Subscribe, which is described in the SIP standard. The SIP aware load broker 150 may then utilize the load factor information received from the load factor aware entities to calculate a Q-value for each entity. That Q-value is related to the current load placed on each load factor aware entity in this embodiment. The location service 124 may then be updated with the Q-values for each load factor aware entity periodically.

The conversion module 172 collects information to be used in calculating the load factor for each load factor aware entity. That information may include non-SIP load factor information from the non-SIP load factor module 166, SIP load factor configuration information from the configured load factor module 162, and SIP load factor information received from the load factor aware entities from the SIP load factor module 168. The conversion module 172 may utilize that information to calculate a load factor for each load factor aware entity and translate that load factor into an SIP Q-value for each of those entities. Thus, the SIP load factor may include both SIP information and non-SIP information.

It should be recognized that load balancing need not be carried out through use of a Q-value. The Q-value is, however, a convenient way to communicate entity loading.

An SIP load distribution module 174 receives the SIP Q-value and associates those SIP Q-values with the appropriate entity or entities. That association may associate the SIP Q-values with a universal resource identifier for the appropriate entity or entities. That new or updated Q-value may then be stored in the location service 124 through the LCS interfacing module 170 and the location service interface 160.

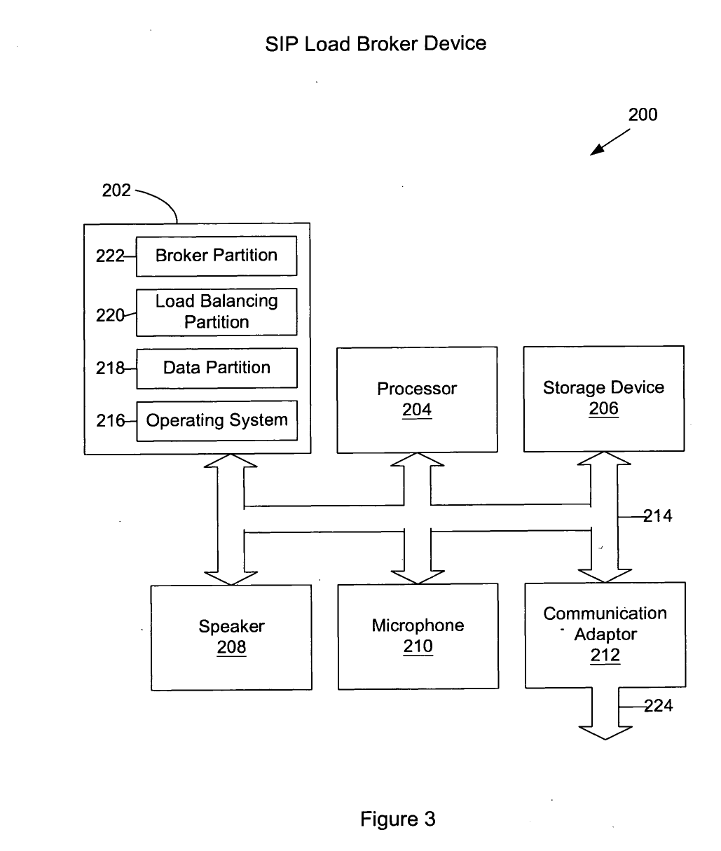

FIG. 3 illustrates an SIP load broker device 200 that may perform load balancing in an SIP network. The SIP load broker device 200 includes memory 202, a processor 204, a storage device 206, a speaker 208, a microphone 210, and a communication adaptor 212. Communication between the processor 204, the storage device 206, the speaker 208, the microphone 210, and the communication adaptor 212 is accomplished by way of a communication bus 214.

The memory 202 may, for example, include random access memory (RAM), dynamic RAM, and/or read only memory (ROM) (e.g., programmable ROM, erasable programmable ROM, or electronically erasable programmable ROM) and may store computer program instructions and information. The memory may furthermore be partitioned into sections in which operating system 216 instructions are stored, a data partition 218 in which data is stored, a load balancing partition 220 in which instructions for carrying out load balancing functionality are stored, and a broker partition 222 in which instructions for carrying out B2BUA functionality are stored. The load balancing partition 220 may store program instructions and allow execution by the processor 204 of the program instructions. The data partition 218 may furthermore store data to be used during the execution of the program instructions.

The processor 204 may, for example, be an Intel® Pentium® type processor or another processor manufactured by, for example Motorola®, Compaq®, AMD®, or Sun Microsystems®. The processor 204 may furthermore execute the program instructions and process the data stored in the memory 202. In one embodiment, the instructions are stored in memory 202 in a compressed and/or encrypted format. As used herein the phrase, “executed by a processor” is intended to encompass instructions stored in a compressed and/or encrypted format, as well as instructions that may be compiled or installed by an installer before being executed by the processor 204.

The storage device 206 may, for example, be a magnetic disk (e.g., floppy disk and hard drive), optical disk (e.g., CD-ROM) or any other device or signal that can store digital information. The communication adaptor 212 permits communication between the SIP load broker device 200 and other devices or nodes coupled to the communication adaptor 212 at the communication adaptor port 224. The communication adaptor 212 may be a network interface that transfers information from nodes on a network to the SIP load broker device 200 or from the SIP load broker device 200 to nodes on the network. The network may be a local or wide area network, such as, for example, the Internet, the World Wide Web, or the network 100 illustrated in FIG. 1. It will be recognized that the SIP load broker device 200 may alternately or in addition be coupled directly to one or more other devices through one or more input/output adaptors (not shown).

The SIP load broker device 200 may also be coupled to other output devices such as, for example, a monitor (not shown), and various input devices such as, for example, a keyboard or mouse (not shown). Moreover, the storage device 206 may not be necessary for operation of the SIP load broker device 200.

The elements 202, 204, 206, 208, 210, and 212 of the SIP load broker device 200 may communicate by way of one or more communication busses 214. Those busses 214 may include, for example, a system bus, a peripheral component interface bus, and an industry standard architecture bus. Moreover, the SIP load broker device 200 may be, for example, an SIP B2BUA

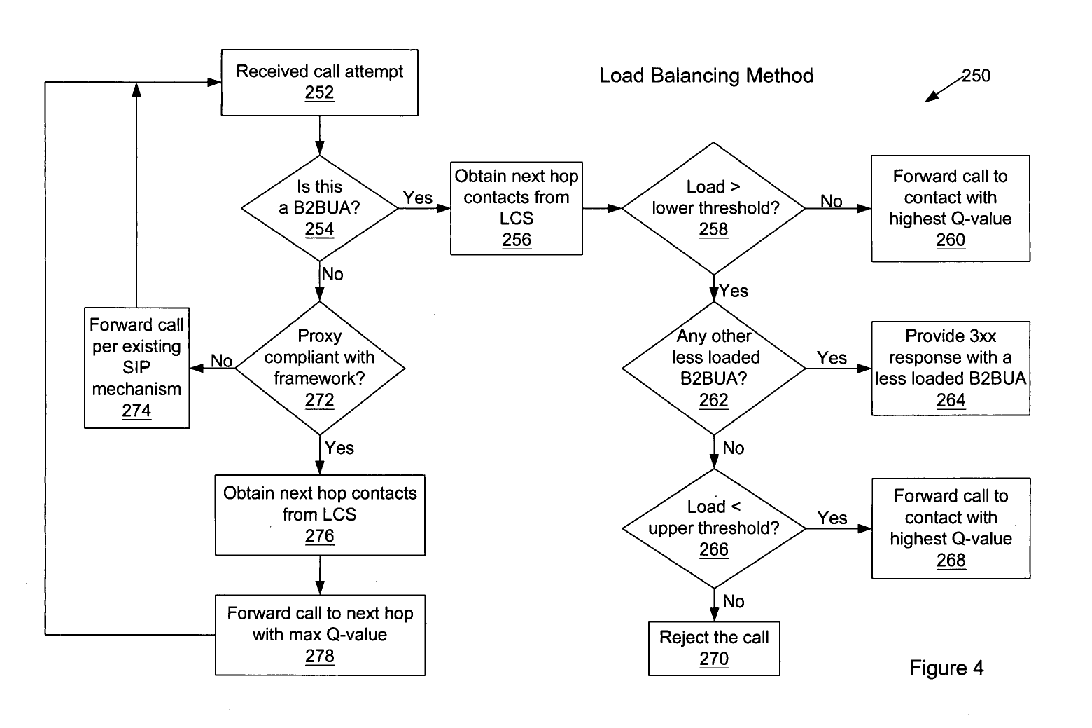

FIG. 4 illustrates a load balancing method 250 for an SIP network. That method provides load balancing for B2BUAs and proxies and assumes that the call is being routed through a B2BUA or proxy. At 252, an SIP network entity receives a call attempt from an SIP entity like a UA. At 254, a decision is made as to whether this entity is a B2BUA. If the call was made through a B2BUA, then the method contacts a location service such as the location service 124 illustrated in FIG. 1, at 256 to obtain information related to the entities that may be utilized as next hop contacts.

The location service 124 will return the entity having the least load and the maximum Q-value, which indicates that entity has a small load and a high priority. The location service 124 may additionally return some or all additional entities that may be utilized as, for example, next hop contacts, along with Q-values associated with those entities.

A determination is made at 258 as to whether the load at the returned entity is greater than a lower threshold. The lower threshold is a load on the next hop entity beneath which the next hop entity is to be used regardless of loading on other next hop contacts. An upper threshold is a load on the next hop entity above which that entity is not to be further loaded by adding more SIP calls to it, regardless of loading on other next hop contacts. Between the lower threshold and upper threshold, the next hop entity in question will be used if it is less loaded than other next hop entities that might alternately be used. If the load on the returned next hop entity is not greater than the lower threshold, then the call is forwarded to the entity having the highest Q-value at 260.

If the load on the least loaded contact entity is greater than the lower threshold at 258, then a determination as to whether there are any other less loaded B2BUAs or proxies is made at 262.

If there is a less loaded B2BUA that may be utilized as a next hop, the a 3xx response is returned to the entity from which the call attempt was made having the address of the less loaded B2BUA and directing that calling entity to utilize the less loaded B2BUA at 264.

If no less loaded B2BUAs are discovered at 262, then a determination is made as to whether the load is lower than the upper threshold. If the load is lower than the upper threshold, then the call is forwarded to the next hop entity having the highest Q-value at 268. If the load is not lower than the upper threshold, then the call is rejected at 270.

If the entity receiving the call attempt is not a B2BUA at 254, then the entity is assumed to be a proxy in this embodiment. A determination as to whether the proxy is compliant with SIP load factoring is made at 272. If the proxy is not compliant with SIP load factoring, then the call is forwarded to the next hop entity without consideration for load balancing at 274. If the proxy is compliant with SIP load factoring, then the location service is contacted at 276 to obtain the next hop contacts and their load factored Q-values. The call is then forwarded to the next hop entity having the maximum Q-value at 278.

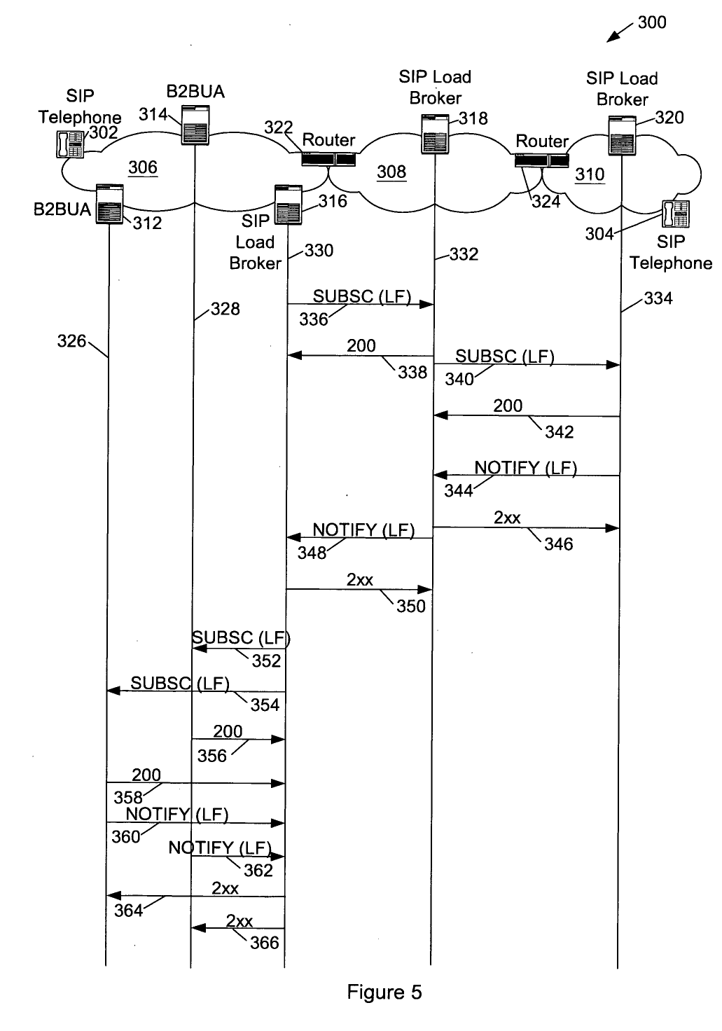

In an embodiment, a method of performing dynamic load distribution within an SIP network is contemplated. In that method, the current or recent load on a first node is determined. That load is then factored into a Q-value. As has been mentioned, the load may be one of two or more factors factored into the Q-value. The Q-value is then transmitted to a second node and possibly other nodes to inform the second and other nodes of the load on the first node so that load may be compared to loads on other nodes that may be used alternately when the second and other nodes decide whether to utilize the first node or an alternate node as, for example, an intermediate, next hop node. FIG. 5 illustrates an example of how such a method may operate.

FIG. 5 is a message flow timeline 300 in an embodiment of dynamic load distribution within an SIP network. The message flow timeline 300 depicts the exchange of Load Factor using Subscribe and Notify messages as exchange mechanisms to exchange information between various SIP Network entities. The message flow timeline 300 also illustrates how the caller administrative domain 306, or sub-network, from which the caller places the call, aggregates load factor information from local B2BUAs and load brokers in remote sub-networks. Moreover, the message flow timeline 300 illustrates how the location database may be updated dynamically with new load information. In addition to SIP information flow, the message flow timeline 300 illustrates the flow of non-SIP information.

Two remote administrative domains or sub-networks are involved in the illustrated embodiment: a call receiver domain 310 to which the call receiver is coupled, and a transit domain 308 that passes information from the caller domain 306 to the call receiver domain 310. The caller domain 306 includes a first B2BUA 312, a second B2BUA 314, and a caller domain SIP enabled load broker 316 in addition to the SIP caller 302. The transit domain 308 includes a transit domain SIP enabled load broker 318. The call receiving domain 310 includes a call receiver domain SIP enabled load broker 320 in addition to the SIP call receiver 304. The caller domain sub-network 306 is coupled to the transit domain sub-network 308 through a first router 322 and the transit domain sub-network 308 is coupled to the call receiver domain sub-network 310 through a second router 324.

Communications originating from the first B2BUA 312 are depicted by lines extending from a first B2BUA timeline 326 and communications received by the first B2BUA 312 are depicted by lines extending to the first B2BUA timeline 326. Communications originating from the second B2BUA 314 are depicted by lines extending from a second B2BUA timeline 328 and communications received by the second B2BUA 314 are depicted by lines extending to the second B2BUA timeline 328. Communications originating from the caller domain SIP enabled load broker 316 are depicted by lines extending from a caller domain SIP enabled load broker timeline 330 and communications received by the caller domain SIP enabled load broker 316 are depicted by lines extending to the caller domain SIP enabled load broker timeline 330. Communications originating from the transit domain SIP enabled load broker 318 are depicted by lines extending from a transit domain SIP enabled load broker timeline 332 and communications received by the transit domain SIP enabled load broker 318 are depicted by lines extending to the transit domain SIP enabled load broker timeline 332. Communications originating from the call receiving domain SIP enabled load broker 320 are depicted by lines extending from a call receiving domain SIP enabled load broker timeline 334 and communications received by the call receiving domain SIP enabled load broker 320 are depicted by lines extending to the call receiving domain SIP enabled load broker timeline 334.

At 336, the caller domain SIP enabled load broker 316 transmits a subscription to the transit domain SIP enabled load broker 318 to register to participate in a load factor exchange service that will cause those entities 316 and 318 to exchange load factor information through Q-values. At 338, the transit domain SIP enabled load broker 318 responds to the subscription with an SIP 200 type response, as described in the SIP specification, to confirm receipt of the subscription.

The transit domain SIP enabled load broker 318 subscribes to the call receiver domain SIP enabled load broker 320 at 340 to register to participate in the load factor exchange service. At 342, the call receipt domain SIP enabled load broker 320 responds to the subscription with an SIP 200 type response to confirm receipt of the subscription.

At 344, the call receipt domain SIP enabled load broker 320 transmits a notify message to the transit domain SIP enabled load broker 318. The notify message provides load factor information for SIP entities in the call receipt domain 310. The transit domain SIP enabled load broker 318 responds at 346 with an SIP 200 type message confirming receipt of the notify message at 344. The load factor information provided may, for example, be included in Q-values for those entities and include load factors for all entities reporting load factors in the transit domain 308 or may provide an address for the least loaded entity in the transit domain 308. Load factor information may also be provided for entities in remote domains such as the caller domain 306.

At 348, the transit domain SIP enabled load broker 318 transmits a notify message to the caller domain SIP enabled load broker 316. That notify message provides load factor information for SIP entities in the transit domain 308 and may also provide load factor information for SIP entities in the call receipt domain 310 or other domains. The caller domain SIP enabled load broker 316 responds at 350 with an SIP 200 type message confirming receipt of the notify message at 348. Such notify and response messages may be sent regularly to update load factor information. That load factor information may furthermore be stored in the location service 124 after each update is received.

At 352, the caller domain SIP enabled load broker 316 transmits a subscription to the second B2BUA 314 to register to participate in the load factor exchange service that will cause those entities 316 and 314 to exchange load factor information through Q-values. Similarly, at 354, the caller domain SIP enabled load broker 316 transmits a subscription to the first B2BUA 312 to register to participate in the load factor exchange service that will cause those entities 316 and 312 to exchange load factor information through Q-values.

At 356, the second B2BUA 314 responds to the subscription at 352 with an SIP 200 type response transmitted to the caller domain SIP enabled load broker 316 to confirm receipt of the subscription, and at 358, the first B2BUA 312 responds to the subscription at 354 with an SIP 200 type response caller domain SIP enabled load broker 316 to confirm receipt of the subscription sent at 354.

At 360, the first B2BUA 312 transmits one of its periodic load factor notification messages to the caller domain SIP enabled load broker 316 and at 362, the second B2BUA 314 transmits one of its periodic load factor notification messages to the caller domain SIP enabled load broker 316. At 364, the caller domain SIP enabled load broker 316 responds to the first B2BUA 312 transmission of 360 with an SIP 200 type response. At 366, the caller domain SIP enabled load broker 316 similarly responds to the second B2BUA 312 transmission of 362 with an SIP 200 type response.

The several embodiments described herein are solely for the purpose of illustration. Persons skilled in the art will recognize from this description other embodiments may be practiced with modifications and alterations limited only by the claims.

1. A method of communicating load, comprising:
determining a load on a first node;
factoring the load into a session initiation protocol Q-value for the first node; and
transmitting the Q-value to a second node.

2. The method of claim 1, further comprising the first node subscribing to a load factor exchange service in a message transmitted to the second node.

3. The method of claim 2, further comprising the second node confirming receipt of the subscription in a message transmitted to the first node.

4. The method of claim 1, further comprising:
a third node requesting the Q-value for the first node from the second node; and
the second node transmitting the Q-value for the first node to the third node.

5. The method of claim 4, wherein the second node also transmits Q-values for a plurality of alternate nodes to the third node.

6. The method of claim 5, further comprising the third node utilizing the one of the first node and the alternate nodes having the lowest Q-value as an intermediate node.

7. An article of manufacture, comprising:
a computer readable medium having stored thereon instructions which, when executed by a processor, cause the processor to:
determine a load on a first node and a load on a second node;
factor the load for at least one of the first node and the second node into a session initiation protocol Q-value; and
direct a transmitting node to relay information through one of the first node and the second node based on the load factor.

8. The article of manufacture of claim 7, wherein the instructions are to cause the processor to transmit the load for the first node and the load for the second node to the transmitting node in the session initiation protocol Q-value.

9. The article of manufacture of claim 8, wherein the transmitting node is to transmit the information to the least loaded of the first node and the second node.

10. The article of manufacture of claim 7, wherein the instructions are to cause the information to be redirected from the first node to the second node when the second node becomes less loaded than the first node.

11. The article of manufacture of claim 7, wherein load is based on at least one metric including call capacity of the first and second nodes, processing capability of the first and second nodes, network bandwidth at the first and second nodes, and network availability of the first and second nodes.

12. The article of manufacture of claim 11, wherein the metrics of the first and second nodes are weighted based on the capacity of the nodes for that metric.

13. The article of manufacture of claim 7, wherein the instructions are further to cause the processor to receive a subscription from the transmitting node and at least one second transmitting node, and wherein the load for at least one of the first node and the second node is caused to be transmitted to subscribing nodes upon request.

14. A session initiation protocol device, comprising:
a network adaptor coupled to a network;
a session initiation protocol load module to receive session initiation protocol load information from session initiation protocol entities on the network through the network adaptor; and
a calculation module to provide load information for at least one of the session initiation protocol entities to a querying entity through the network adaptor.

15. The session initiation protocol device of claim 14, wherein the calculation module is furthermore to provide loads for a plurality of session initiation protocol entities to the querying entity.

16. The session initiation protocol device of claim 14, wherein the load information for the session initiation protocol entities is based on at least one metric including call capacity, processing capability, network bandwidth, and network availability.

17. The networked system of claim 14, wherein the metrics of the entities are weighted based on their capacity for that metric.

18. The networked system of claim 14, wherein the load of the session initiation protocol entity is transmitted to the querying entity as a factor in a Q-value.

19. A location service, comprising:
a data storage device to contain a cross reference to session initiation protocol entities coupled to a network and a load factor associated with session initiation protocol entities;
a network adaptor coupled to the network; and
a processor coupled to the data storage device and the network adaptor.

20. The location service of claim 19, wherein the processor is to retrieve the load factor associated with at least one of the session initiation protocol entities when requested to do so by a requesting session initiation protocol entity and transmit that load information to the requesting session initiation protocol entity through the network adaptor.

21. The location service of claim 20, wherein the load factor is transmitted as a factor in a Q-value.

22. A session initiation protocol load balancing system, comprising:
a load broker coupled to a network to gather load information from session initiation protocol entities coupled to the network and calculate a load factor for those session initiation protocol entities; and
a location service to maintain a cross reference to addresses for the session initiation protocol entities coupled to the network and associate the addresses to the load factors obtained from the load broker for those session initiation protocol entities.

23. The session initiation protocol load balancing system of claim 22, wherein the location service is to retrieve the load factor associated with at least one of the session initiation protocol entities when requested to do so by a requesting session initiation protocol entity and transmit that load information to the requesting session initiation protocol entity.

24. The session initiation protocol load balancing system of claim 23, wherein the load factor is transmitted as a factor in a Q-value.
